(19) United States
(12) Patent Application Publication
(10) Pub. No.: US 2005/0201010 A1
(43) Pub. Date: Sep. 15, 2005

(54) Disc media retainer

(76) Inventors: Yiren Hong, Singapore (SG); Mo Xu, Singapore (SG); TakKoon Ooi, Singapore (SG)

Correspondence Address: Seagate Technology LLC, 1280 Disc Drive, Shakopee, MN, 55379, US

(21) Appl. No.: 10/799,317

(22) Filed: Mar. 12, 2004

(51) Int. Cl. G11B 17/02

(52) U.S. Cl. 360/99.12

(57) ABSTRACT

A disc media retainer includes a disc hub member, an annular flange, and a data storage disc. The disc hub member includes a threaded central bore that extends between an open top and an open bottom. The threaded central bore of the disc hub member is configured to receive a threaded spindle hub. The annular flange is attached to the disc hub member and surrounds the central bore. The data storage disc is mounted on the annular flange and includes a central opening that is defined by an interior edge that surrounds the disc hub member.

### FIELD OF THE INVENTION

The present invention generally relates to a disc media retainer, and more particularly, but not by limitation to a disc media retainer having a low profile.

### BACKGROUND OF THE INVENTION

Modern computers employ various forms of storage systems for storing programs and data. These storage systems include disc drive systems that operate under the control of a computer to record information to, or retrieve information from, one or more data storage discs using reading and writing heads.

The data storage discs are generally supported for rotation on a spindle hub that is rotatably driven by a motor of the disc drive. The spindle hub can be a rotatable shaft or a sleeve surrounding a shaft of a bearing cartridge, for example. The discs must be secured to the spindle hub such that proper registration of the discs for reading and/or writing purposes can be achieved. Additionally, the discs must be mounted securely to the spindle hub to prevent them from dislodging and moving in the axial or radial direction once mounted to the spindle hub. Also, it is desirable that the discs be mounted to the spindle hub without deforming the discs, which would adversely affect the reading and writing performance of the heads. Finally, it is desirable that the height required to mount the discs to the spindle hub be minimized to meet the never-ending demands for smaller and shorter disc drives. This is particularly important for the formation of compact flash type I disc drives, which have a thickness of only 3.3 millimeters.

Various methods have been used to mount the discs to the spindle hub. Most disc drives utilize a disc clamp that includes a circular plate that attaches to a top surface of the spindle hub with one or more screws. One or more discs are pinched between the circular plate and a shoulder of the spindle hub. Unfortunately, the circular plate and the screw undesirably add height to the disc drive beyond the height of the spindle hub. In addition, the pinching of the discs can produce localized stresses in the discs, which distort the shape of the discs at the inner diameter thereby reducing data reading and writing performance.

Discs can also be mounted to the spindle hub using a heat-shrink ring, which is attached to the top of the spindle hub. This type of disc clamp is often referred to as a shrink-fit disc clamp. A ring is heated so that it expands such that the inner diameter of the ring is greater than the outer diameter of the spindle hub. A tool is then used to transfer the heated ring to the top of the disc stack and to apply a clamping force to the heated ring. The clamping force is maintained on the ring as it cools resulting in the application of a substantially uniform axial load to the discs. Unfortunately, mounting of the discs to the drive using such a shrink-fit disc clamp can be complicated and problems with slippage of the ring on the spindle hub can arise.

There exists a never-ending demand for improvements to disc drives including the manner in which the data storage discs are mounted to the spindle hub. In particular, it is desirable to securely mount discs to the spindle hub without adding to the height of the disc drive.

### SUMMARY OF THE INVENTION

The present invention generally relates to a disc media retainer that is used to mount one or more data storage discs to a rotatable spindle hub. The disc media retainer includes a data storage disc and a threaded central bore. The threaded central bore is configured to receive a threaded spindle hub for mounting the disc thereto.

In accordance with one embodiment of the invention, the disc media retainer includes a disc hub member, an annular flange, and a data storage disc. The disc hub member includes the threaded central bore that extends between an open top and an open bottom. The annular flange is attached to the disc hub member and surrounds the central bore. The data storage disc is mounted on the annular flange and includes a central opening that is defined by an interior edge that surrounds the disc hub member.

In accordance with another embodiment of the invention, the disc media retainer includes a data storage disc having a disc hub portion. The disc hub portion includes a the threaded central bore that extends between an open top and an open bottom.

Other features and benefits that characterize embodiments of the present invention will be apparent upon reading the following detailed description and review of the associated drawings.

### BRIEF DESCRIPTION OF THE DRAWINGS

FIG. 1 is a top plan view of an example of a disc drive with a top cover removed, with which embodiments of the present invention are useful.

FIG. 2 is a cross-sectional view of a disc drive that includes a disc media retainer in accordance with embodiments of the invention.

FIG. 3 is a cross-sectional view of a disc media retainer in accordance with embodiments of the invention.

FIG. 4 is a cross-sectional view of a disc drive that includes a disc media retainer in accordance with embodiments of the invention.

FIG. 5 is a cross-sectional view of a disc drive that includes a disc media retainer in accordance with embodiments of the invention.

FIG. 6 is a cross-sectional view of a disc drive that includes a disc media retainer in accordance with embodiments of the invention.

### DETAILED DESCRIPTION OF ILLUSTRATIVE EMBODIMENTS

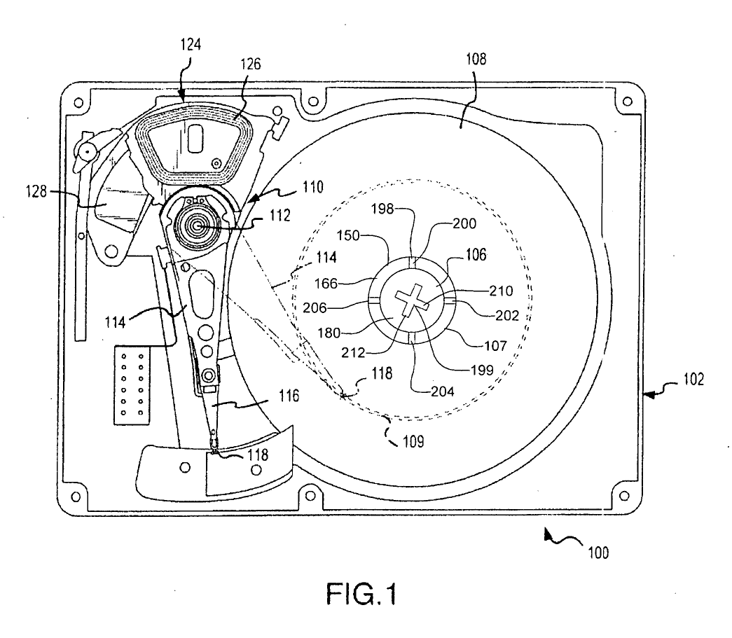

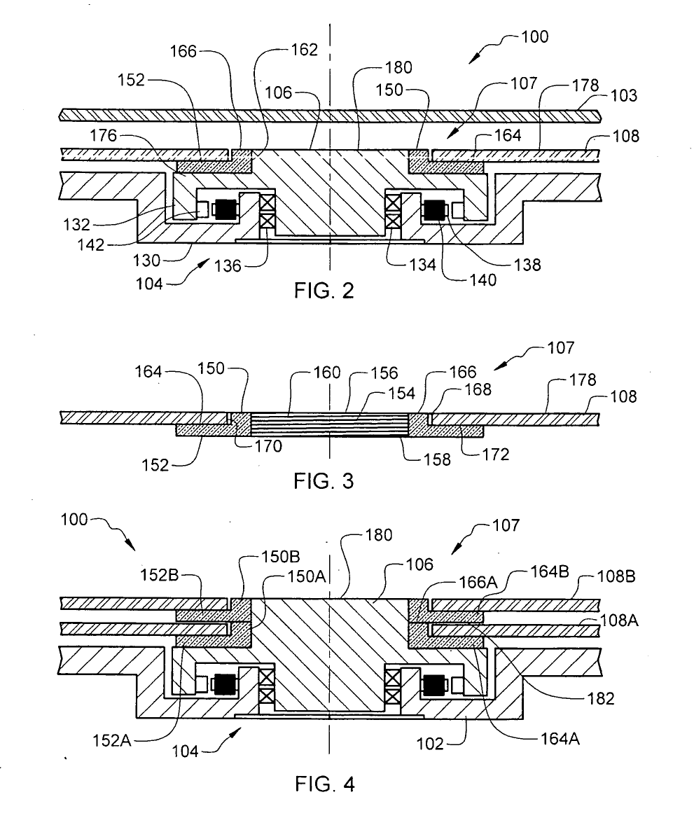

FIG. 1 is a top plan view of an example of a disc drive 100 with which embodiments of the present invention are useful. Disc drive 100 includes a base plate 102 to which various components of disc drive 100 are mounted. A top cover 103 (FIG. 2) cooperates with base 102 to form an internal, sealed environment for the components of the disc drive. Disc drive 100 includes a spindle motor 104 (FIG. 2) that is configured to rotate a spindle hub 106 at a desired speed. A disc media retainer 107 of the present invention mounts to spindle hub 106 and includes one or more data storage discs 108.

Information is written to and/or read from tracks 109 on discs 108 through the use of an actuator assembly 110 that rotates about a bearing shaft assembly 112, which is positioned adjacent to discs 108. Actuator assembly 110 includes a plurality of actuator arms 114 having one or more flexures 116 that extend from each of the actuator arms 114 toward discs 108. A head 118 is mounted at a distal end of each of the flexures 116 and includes an air bearing slider (not shown) that enables the head 118 to fly in close proximity above the corresponding surface of the associated data storage disc 108. Heads 118 can each include read and write elements that are supported by an air bearing slider and are configured to perform the desired read or write operation on the corresponding disc 108.

The radial position of the heads 118 is controlled through the use of a voice coil motor (VCM) 124, which typically includes a coil 126 attached to actuator assembly 110, as well as one or more permanent magnets 128 that establish a magnetic field in which the coil 126 is immersed. The controlled application of current to coil 126 causes magnetic interaction between permanent magnets 128 and coil 126 so that coil 126 moves in accordance with the well known Lorentz relationship. As coil 126 moves, actuator assembly 110 pivots about the bearing shaft assembly 112 and heads 118 are caused to move across the surfaces of discs 108.

As mentioned above, motor 104 can be any suitable motor that is configured to rotate spindle hub 106 and disc media retainer 107 mounted thereto at a desired speed. For example, motor 104 can be a brushless DC motor that operates in a conventional manner. A representative sectional view of such a motor 104 is provided in FIG. 2. Motor 104 generally includes a stator 130 and a rotor 132. Stator 130 includes base 102 or a base portion secured to base 102. Stator 130 also includes a bearing cartridge or housing 134. Rotor 132 includes spindle hub 106, which is journaled in an axially spaced bearing pair 136 in bearing cartridge 134. Stator 130 of motor 104 includes a magnetic core having a plurality of equally, circumferentially spaced salient poles 138, on which coils 140 are disposed. Spindle hub 106 is generally umbrella shaped and peripherally carries an annular permanent magnet 142, which is spot magnetized.

One embodiment of disc media retainer 107 includes a disc hub member 150, an annular flange 152, and data storage disc 108, shown assembled in a disc drive 100 in FIG. 2 and separated therefrom in FIG. 3. Disc hub member 150 includes a central bore 154 that extends between an open top 156 and an open bottom 158. The central bore 154 includes a threaded interior surface 160 that is configured to screw onto a threaded exterior cylindrical surface 162 of spindle hub 106 for threaded engagement therewith. Annular flange 152 is attached to disc hub member 150 and surrounds central bore 154. Annular flange 152 extends radially from disc hub member 150 and includes a disc support surface 164 that is preferably recessed from topside 166 of disc hub member 150. Data storage disc 108 is mounted to disc support surface 164 of annular flange 152 and includes a central opening 168 that is defined by an interior edge 170, which surrounds disc hub member 150. Disc hub member 150 and annular flange 152 are preferably formed integral with each other, as shown in FIGS. 2 and 3.

The mounting of disc 108 to disc support surface 164 is preferably completed prior to the installation of disc hub member 154 to spindle hub 106. In accordance with one embodiment of the invention, disc 108 is securely mounted to disc support surface 164 of annular flange 152 using an adhesive 172. Adhesive 172 can be a pressure sensitive adhesive (PSA), an epoxy, or other suitable adhesive. Adhesive 172 prevents disc 108 from moving in the axial or radial direction relative to disc support surface 164 while adding minimal height to disc drive 100 as compared to prior art disc mounting methods. Additionally, the use of adhesive 172 to mount disc 108 to disc support surface 164 avoids the application of axial loads on disc 108. As a result, disc media retainer 107 avoids the disc warping problems of prior art disc mounting methods.

As mentioned above, disc media retainer 107 is mounted to spindle hub 106 by screwing disc hub member 150 onto threaded exterior cylindrical surface 162 of spindle hub 106. Disc hub member and the attached data storage disc 108 are rotated relative to spindle hub 106 until a bottom surface 174 of annular flange 152 engages an annular shoulder 176 of spindle hub 106. Preferably, top surface 166 of disc hub member 150 and a top surface 178 of disc 108 are positioned at or below top surface 180 of spindle hub 106. Additionally, top surface 178 of data storage disc 108 is preferably formed at or below top surface 166 of disc hub member 150. As a result, disc media retainer 107 avoids adding height to the disc drive 100. This is particularly useful when disc media retainer 107 is used in the formation of very compact disc drives, such as those meeting compact flash type I specifications.

In accordance with another embodiment of the invention, disc media retainer 107 is configured to support multiple discs 108 on spindle hub 106, as shown in FIG. 4. In accordance with this embodiment of the invention, disc media retainer 107 includes a plurality of disc hub members, such as first and second disc hub members 150A and 150B and corresponding first and second annular flanges 152A and 152B attached thereto. A first data storage disc 108A is mounted to first annular flange 152A at disc support surface 164A, as discussed above. Likewise, a second data storage disc 108B is mounted to disc support surface 164B of second annular flange 152B. The first and second disc hub members 150A and 150B each include a central bore having a threaded interior surface that receives the threaded exterior cylindrical surface 162 of spindle 106, as discussed above. First disc 108A is preferably positioned at or below top surface 166A of disc hub member 150A to avoid application of an axial load to first disc 108A by a bottom surface 182 of second annular flange 152B. As a result, second disc hub member 150B is fully installed onto spindle hub 106 when bottom surface 182 engages top surface 166A of first disc hub member 150A. Alternatively, first disc 108A can be positioned at or above top surface 166A to allow for the application of an axial load to disc 108A by bottom surface 182 when second disc hub member 150B is fully installed on spindle hub 106. The magnitude of such an axial load is preferably limited to prevent first disc 108A from becoming warped. Accordingly, disc media retainer 107 of the present invention can be configured to mount several data storage discs 108 to spindle hub 106.

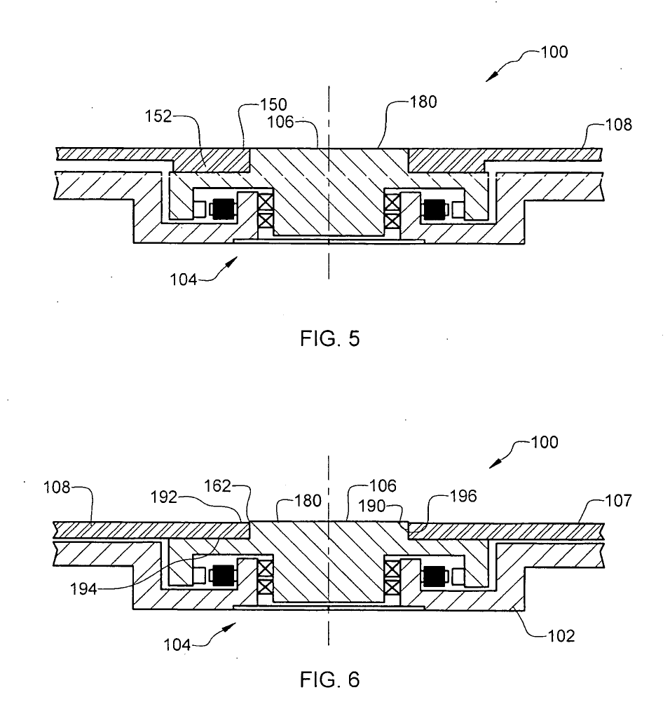

In accordance with another embodiment of the invention, disc hub member 150, annular flange 152 and data storage disc 108 are integrally formed, as shown in FIGS. 5 and 6. As a result, this embodiment of the invention simplifies manufacture of disc drive 100 by eliminating the manufacturing step of adhering disc 108 to annular flange 152. In the embodiment shown in FIG. 5, disc 108 includes a thick interior portion that includes the disc hub member portion 150 and the annular flange portion 152.

In accordance with the embodiment of the invention shown in FIG. 6, disc media retainer 107 is basically formed by a thick data storage disc 108 having a central bore 190 that extends between an open top at top surface 192 and an open bottom at bottom surface 194. Central bore 190 also includes a threaded interior surface 196 that is configured to receive the threaded exterior cylindrical surface 162 of spindle hub 106. Preferably, data storage disc 108 is at least 1.0-1.4 millimeters thick at central bore 190 to allow for the formation of three to five threads in central bore 190 to ensure sufficient threaded engagement with spindle hub 106 to secure disc 108 thereto.

The mounting of disc media retainer 107 to spindle 106 is preferably assisted by an assembly feature 198 on disc hub member 150 and an assembly feature 199 top surface 180 of spindle hub 106, as shown in FIG. 1. In accordance with one embodiment of the invention, the assembly feature 198 of disc media retainer 107 includes a plurality of slots, such as slots 200, 202, 204 and 206, formed in top surface 166 of disc hub member 150 adjacent open top 156 (FIG. 3) of central bore 154. Preferably, each of the slots formed in disc hub member 150 are paired with an opposing slot. Examples of such slot pairs are slots 200 and 204 and slots 202 and 206. Assembly feature 199 of spindle hub 106 includes at least one slot, such as slot 210 or 212, as shown in FIG. 1.

Assembly feature 198 of disc media retainer 107 and assembly feature 199 of spindle hub 106 can assist in the mounting of disc media retainer 107 to spindle hub 106 through the use of suitable tools. For example, one tool can interface the assembly feature 198 of disc media retainer 107 while a second tool interfaces assembly feature 199 of spindle hub 106. The tools can be used to rotate disc media retainer 107 relative to spindle hub 106 in order to screw disc media retainer 107 onto the threaded cylindrical portion 162 of spindle hub 106 to secure disc media retainer 107 thereon.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc media retainer while maintaining substantially the same functionality without departing from the scope and spirit of the present invention.

1. A disc media retainer comprising:
a disc hub member having a central bore extending between an open top and an open bottom, the central bore having a threaded interior surface configured to receive a threaded spindle hub;
an annular flange attached to the disc hub member and surrounding the central bore; and
a data storage disc having a central opening defining an interior edge surrounding the disc hub member, the disc mounted on the annular flange.

2. The disc media retainer of claim 1, wherein the disc is mounted on the annular flange by an adhesive.

3. The disc media retainer of claim 1, wherein the disc hub member includes an assembly feature adjacent to the open top, the assembly feature is configured to assist in the mounting of the disc media retainer to a spindle.

4. The disc media retainer of claim 3, wherein the assembly feature includes a plurality of slots.

5. The disc media retainer of claim 4, wherein two of the slots are positioned on opposite sides of the disc hub member.

6. The disc media retainer of claim 1, wherein the disc hub member, the annular flange and the data storage disc are integrally formed.

7. The disc media retainer of claim 1, wherein the disc includes a top surface that is positioned at or below a top surface of the disc hub member surrounding the open top.

8. The disc media retainer of claim 1 including:
a second annular flange attached to the disc hub member; and
a second data storage disc having a central opening defined by an interior edge surrounding the disc hub member, the second data storage disc mounted on the second annular flange.

9. A disc drive comprising:
a rotatable spindle including a threaded cylindrical portion; and
the disc media retainer of claim 1, wherein the threaded interior surface of the disc hub member is in threaded engagement with the threaded cylindrical portion of the spindle.

10. The disc drive of claim 9, wherein the spindle includes an assembly feature configured to assist in the mounting of the disc media retainer to the spindle.

11. The disc drive of claim 10, wherein the assembly feature is formed in a top surface of the spindle.

12. The disc drive of claim 10, wherein the assembly feature includes at least one slot.

13. The disc drive of claim 9, wherein the disc media retainer is positioned at or below a top surface of the spindle.

14. The disc drive of claim 9, wherein a top surface of the disc hub member adjacent the open top is positioned at or below a top surface of the spindle.

15. A data storage disc comprising a disc hub portion having a central bore extending between an open top and an open bottom, the central bore having a threaded interior surface configured to receive a threaded spindle hub.

16. The disc of claim 15 including a data storage portion supported by the disc hub portion.

17. The disc of claim 16, wherein the data storage portion is thinner than the disc hub portion.

18. The disc of claim 15, wherein the disc hub portion is formed of metal.

19. The disc of claim 15, wherein the disc hub portion includes an assembly feature adjacent the open top, the assembly feature configured to assist in the rotation of the disc during installation of the disc onto a spindle hub.

20. The disc of claim 19, wherein the assembly feature includes a plurality of slots.

21. The disc of claim 20, wherein two of the slots are positioned on opposite sides of the disc hub portion.

22. A disc drive comprising:
a rotatable spindle including a threaded cylindrical portion; and
the data storage disc of claim 15, wherein the threaded interior surface of the disc hub portion is in threaded engagement with the threaded cylindrical portion of the spindle.

23. The disc drive of claim 22, wherein the spindle includes an assembly feature configured to assist in the mounting of the data storage disc to the spindle.

24. The disc drive of claim 23, wherein the assembly feature is formed in a top surface of the spindle.

25. The disc drive of claim 23, wherein the assembly feature includes at least one slot.

26. The disc drive of claim 22, wherein the data storage disc is positioned at or below a top surface of the spindle.

27. A disc drive storage system comprising:
a rotatable spindle including a threaded cylindrical portion; and
a disc media retainer comprising:
a disc hub member having a central bore extending between an open top and an open bottom, the central bore having a threaded interior surface in threaded engagement with the threaded cylindrical portion of the spindle;
an annular flange attached to the disc hub member and surrounding the central bore; and
a data storage disc having a central opening defined by an interior edge surrounding the disc hub member, the disc mounted on the annular flange.

28. The disc drive of claim 27, wherein the disc hub member includes an assembly feature adjacent the open top, the assembly feature configured to assist in the mounting of the disc media retainer to the spindle hub.

29. The disc drive of claim 28, wherein the assembly feature includes a plurality of slots.

30. The disc drive of claim 29, wherein two of the slots are positioned on opposite sides of the hub member.

31. The disc drive of claim 27, wherein the spindle includes an assembly feature configured to assist in the mounting of the disc media retainer to the spindle.

32. The disc drive of claim 31, wherein the assembly feature is formed in a top surface of the spindle.

33. The disc drive of claim 31, wherein the assembly feature includes at least one slot.

34. The disc drive of claim 27, wherein the disc includes a top surface that is positioned at or below a top surface of the disc hub member surrounding the open top.

35. The disc drive of claim 27, wherein the disc media retainer is positioned at or below a top surface of the spindle.
